(19) United States
(12) Patent Application Publication
(10) Pub. No.: US 2013/0268446 A1
(43) Pub. Date: Oct. 10, 2013

(54) SYSTEM AND METHOD FOR ENTRY OF STRUCTURED DATA

(71) Applicant: TALKTO, INC., Wilmington, DE (US)

(72) Inventors: Brian F. Buschmann, Fiesole (IT); Felice Carraro, Seano Carmignano (IT); Iacopo Carraro, Seano Carmignano (IT); Stuart J. Levinson, Boston, MA (US); Riley W. Crane, Boston, MA (US); Sean Johnson, Chapel Hill, NC (US); James M. Byrum, San Francisco, CA (US)

(21) Appl. No.: 13/860,498

(22) Filed: Apr. 10, 2013

Related U.S. Application Data
(60) Provisional application No. 61/622,488, filed on Apr. 10, 2012.

(51) Int. Cl. G06Q 30/00

(52) U.S. Cl. CPC G06Q 30/01
USPC 705/304

(57) ABSTRACT

Systems and methods for enabling communication between a user and at least one entity by a communication service are disclosed. In one example, the method comprises providing at least one predefined text string for display to the user on a device, the at least one predefined text string comprising an inquiry to the at least one entity, receiving a structured text input associated with the at least one predefined text string, and transmitting a message to another device having the at least one predefined text string and the structured text input to the at least one entity.

### RELATED APPLICATIONS

This application claims priority under 35 U.S.C. §119(e) to U.S. Provisional Application Ser. No. 61/622,488, entitled “SYSTEM AND METHOD FOR ENTRY OF STRUCTURED DATA IN A TEXT MESSAGING INTERFACE,” filed on Apr. 10, 2012, which is hereby incorporated herein by reference in its entirety.

### NOTICE OF MATERIAL SUBJECT TO COPYRIGHT PROTECTION

Portions of the material in this patent document are subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND

1. Technical Field

Embodiments disclosed herein relate generally to systems and methods for communication tool, and, more particularly, to systems and processes of establishing communications with entities.

2. Related Art

People may seek to personally communicate with businesses, organizations or other entities for various reasons. A person may wish, for example, to provide feedback, address customer service issues, make reservations, inquire about products or services, or find information not available through other methods. There are many communication options available, for example, calling or sending an email to a local business, calling or sending an email to a corporate office or initiating a web chat on the entity's website.

Typically the person performs a search using a search engine in an attempt to initiate communication with the entity. The person is searching for an implicit or explicit token, such as a phone number, an email address, or a Web contact form, that can be used to initiate communication with the entity. These tokens for any type of entity can be found on the entity's Web page (typically by following a “Contact” link). These tokens can also be found on place pages (specific type of Web page that describes a specific addressable geographic location), or using various service websites (review websites) or applications.

It is appreciated that some customers find online forms of communication, for example email or web-chat systems, more convenient than making a phone call. Online communication may be preferred in noisy environments where an audio conversation may be difficult or where conversations can be overheard by others. Online communication does not tie up phone lines and may allow for multi-tasking and interruptions. For these reasons, there is demand for businesses and organizations to provide online forms of communication.

Businesses, organizations and other entities may also prefer to channel customer service requests to online forms of communication so as to quickly and cheaply address any questions or concerns. But customers often find online forms of communication with businesses, organizations and other entities can be inconsistent. Response times to email inquires can depend on the nature of the inquiry, the size of the entity, and whether the entity has a dedicated customer service team. Different chat solutions exist for each business or organization with each chat solution having its own nomenclature, keyboard and mouse commands, look and feel, way of behaving, and software system requirements.

### SUMMARY

It is appreciated that even with all these communication options there is a communication gap between people attempting to initiation communication with an entity and the entities supplying the response. For example, if a person wants to contact a local branch of a chain store to find out if the store carries a specific brand of shoe in his or her size, the person would have to go to the store's website or search for the store in a search engine. After finding the local store's phone number, the person may call the store and ask an employee of the store to check inventory for that shoe. If the local store does not have the shoe in stock, the person would have to find and call the next store and repeat the process. Instead, the person may email corporate customer service and wait for a response, which may not come for a few days, or if one exists, initiate a web-chat with the corporate customer service.

These extra communication steps form the communication gap and can be time consuming and frustrating for the person. Some solutions to this communication gap include web-chat systems provided by businesses on their websites. These web-chat systems allow a person visiting a business or organization's web site to initiate and conduct an online chat discussion with a representative of the business. In these web chat systems, the visitor initiates a chat and is then able to chat with a single available representative of the business. Typical systems are designed to allow an entity in the system to relate to one user or customer. Therefore, these systems necessitate a dedicated customer support person or team. However, not every business or organization can offer such a chat system or offer a team of dedicated customer support representatives.

Accordingly, there is a need for systems and methods for connecting individuals with businesses, organizations and other entities that allow the individuals to obtain information quickly and without the extra communication steps. Aspects and examples disclosed herein are directed to a system and method of providing a communication service that bridges the gap between the individual users and the entities and offers a single, universal communication solution. The communication service allows for the individuals to send general inquiries to the communication service without first searching for contact information or having any prior contact with the entity.

The communication service provides for the entity to utilize its existing pool of employees and representatives to communicate on its behalf. The interfaces described herein further allow for any representative or agent of the entity to answer incoming messages by the users. Furthermore, the interfaces allow for the agents to respond to inquiries from anywhere using a mobile device. Such systems and methods streamline communications between individuals and organizations and allow for seamless transfer of information from the organization to the individual.

According to one aspect, a computer system for providing structured communication for communication between a user and at least one entity is disclosed. In one example the system comprises a memory, a display, and at least one processor coupled to the memory and the display, the at least one processor configured to provide at least one predefined text string for display to the user on a device, the at least one predefined text string comprising an inquiry to the at least one entity, receive a structured text input associated with the at least one predefined text string, and transmit a message to another device having the at least one predefined text string and the structured text input to the at least one entity.

The at least one processor can be further configured to provide the at least one predefined text string comprising inquires pertinent to trade of the at least on entity. In addition, the at least one processor can be also configured to provide the at least one predefined text string comprising common inquiry to a business type associated with the at least on entity. Further, the at least one processor may be configured to provide for display to the user an auto-text selection. In one example, the at least one processor is further configured to provide for display at least one auto-text input adjacent to a messaging field in response to receiving an input associated with the auto-text selection. In this example, the at least one processor is further configured to input into the messaging field the at least one auto-text input in response to receiving an input selection of the at least one auto-text input.

In another example, the at least one processor is further configured to provide for display at least one prompt selection for entering structured text within the at least one predefined text string. In yet another example, the at least one prompt selection comprises a scroll bar displaying a selection of the structured text input. In one example, the at least one processor is further configured to receive a search input from the user for the at least one entity and to provide search results including the at least one entity based on the search input. In another example, the at least one processor is further configured to provide at least one predefined text string comprising a plurality of predetermined inquires organized into categories.

According another aspect, a method for providing structured communication for communication between a user and at least one entity is disclosed. In one example the method comprises providing at least one predefined text string for display to the user on a device, the at least one predefined text string comprising an inquiry to the at least one entity, receiving a structured text input associated with the at least one predefined text string, and transmitting a message to another device having the at least one predefined text string and the structured text input to the at least one entity.

In another example, the method comprises providing the at least one predefined text string comprising inquires pertinent to trade of the at least on entity. The method may further include providing the at least one predefined text string comprising common inquiry to a business type associated with the at least on entity. In addition, the method may further comprise providing for display to the user an auto-text selection.

In one example, the method further comprises providing for display at least one auto-text input adjacent to a messaging field in response to receiving an input associated with the auto-text selection. In yet another example, the method comprises providing into the messaging field the at least one auto-text input in response to receiving an input selection of the at least one auto-text input.

In another example, the method further comprises providing for display at least one prompt selection for entering structured text within the at least one predefined text string. The method may further comprise providing for display the at least one prompt selection comprising a scroll bar displaying a selection of the structured text input. In one example, the method further comprises receiving a search input from the user for the at least one entity and to provide search results including the at least one entity based on the search input.

According to another aspect, a non-transitory computer readable medium providing structured communication for communication between a user and at least one entity is disclosed. In one example, the non-transitory computer readable medium having stored thereon sequences of instruction that are capable of causing at least one processor to provide at least one predefined text string for display to the user on a device, the at least one predefined text string comprising an inquiry to the at least one entity, receive a structured text input associated with the at least one predefined text string, and transmit a message to another device having the at least one predefined text string and the structured text input to the at least one entity.

Still other aspects, embodiments and advantages of these exemplary aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Any embodiment disclosed herein may be combined with any other embodiment. References to “an embodiment,” “an example,” “some embodiments,” “some examples,” “an alternate embodiment,” “various embodiments,” “one embodiment,” “at least one embodiment,” “this and other embodiments” or the like are not necessarily mutually exclusive and are intended to indicate that a particular feature, structure, or characteristic described in connection with the embodiment may be included in at least one embodiment. The appearances of such terms herein are not necessarily all referring to the same embodiment.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of the invention. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. In the figures:

FIG. 1 is a block diagram of one example of a distributed communication system suitable for incorporating various aspects of the present invention;

FIG. 2 is one example of an interface provided in the distributed communication system, according to one embodiment;

FIG. 3A is one example of an interface provided in the distributed communication system, according to one embodiment;

FIG. 3B is one example of an interface provided in the distributed communication system, according to one embodiment;

FIG. 4 is one example of an interface for inputting structured information, according to one embodiment;

FIG. 5A is one example of an interface for inputting structured information, according to one embodiment;

FIG. 5B is one example of an interface for inputting structured information, according to one embodiment;

FIG. 6A is one example of an interface for inputting structured information, according to one embodiment;

FIG. 6B is one example of an interface for inputting structured information, according to one embodiment;

FIG. 6C is another example of an interface for inputting structured information, according to one embodiment;

FIG. 6D is another example of an interface for inputting structured information, according to one embodiment;

FIG. 7 is one example of an interface for viewing third party information to input structured information, according to one embodiment;

FIG. 8A is one example of an interface for viewing third party information to input structured information, according to one embodiment;

FIG. 8B is one example of an interface for viewing third party information to input structured information, according to one embodiment; and

FIG. 9 is a block diagram of one example of a computer system that may be used to perform processes and functions disclosed herein.

### DETAILED DESCRIPTION

As described above, currently existing communication options do not offer seamless communication desired by the user, necessitating additional steps or discrete, proprietary interfaces. Accordingly, there is a need for systems and methods that bridge the communication gap and make the additional steps or the proprietary interfaces transparent to the user. Aspects and examples disclosed herein relate to systems and methods for a communication service that provide a quick and seamless way for individual users to chat with entities. One example of systems and methods for abstract communication with one or more entities is disclosed in U.S. patent application Ser. No. 13/557,926, titled SYSTEM AND METHOD FOR ABSTRACT COMMUNICATION, filed on Jul. 25, 2012, which is hereby incorporated herein by reference in its entirety. In various embodiments further described below, the systems and methods include a user interface that provides for the user to enter and provide structured or semi-structured information within a text messing application or interface. Structured information may include any information that may be commonly used to communicate with a business, for example, take out and delivery information, parcel tracking information, appointment information, reservation information, or car dispatch information, as well as any other information that may include a predefined set of information requested by a business in a transaction.

It is to be appreciated that examples of the methods and apparatuses discussed herein are not limited in application to the details of construction and the arrangement of components set forth in the following description or illustrated in the accompanying drawings. The methods and apparatuses are capable of implementation in other examples and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, components, elements or acts of the systems and methods herein referred to in the singular may also embrace examples including a plurality, and any references in plural to any example, component, element or act herein may also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

### Communication Service

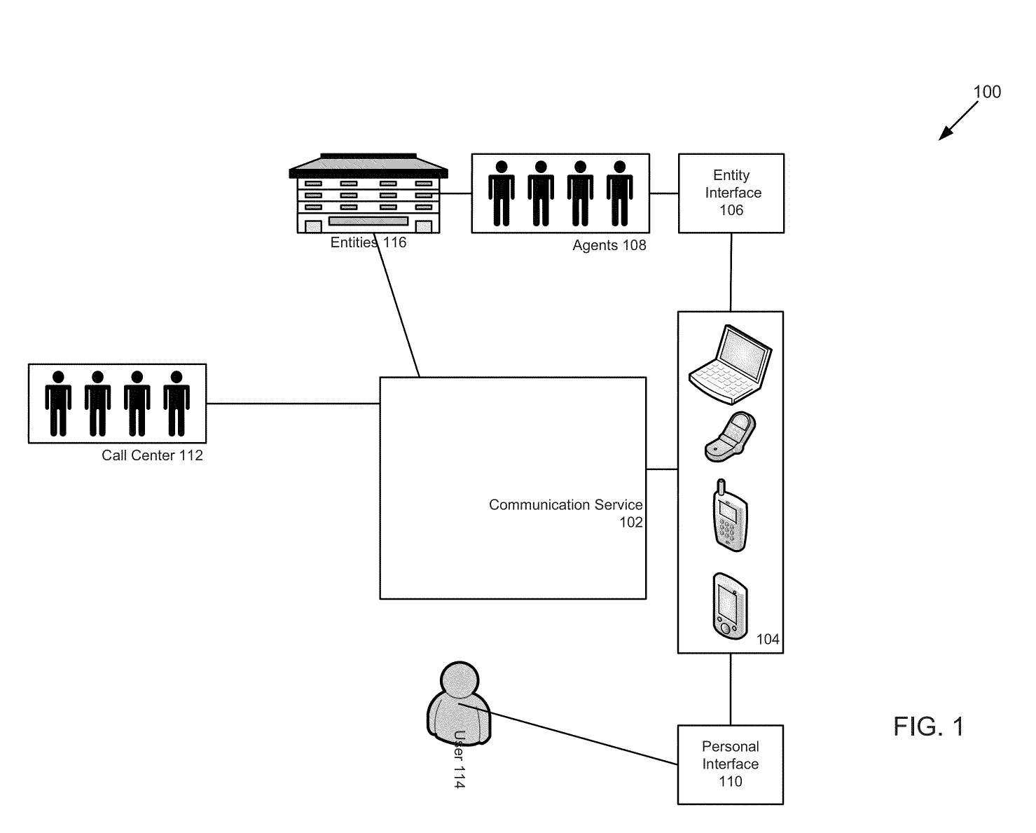

FIG. 1 shows a distributed communication system 100 including a communication service 102 for managing and enabling communication of information between individuals and various entities, such as, organizations and businesses, such as the communication system described in U.S. patent application Ser. No. 13/611,997, filed on Sep. 12, 2012, titled MULTI-USER COMMUNICATION SYSTEM AND METHOD, which is hereby incorporated herein by reference in its entirety. The distributed system can include the communication service 102, devices 104, an entity interface 106, agents 108, a personal interface 110, and a call center 112, each described in more detail below. In one example, communication service 102 allows one or more users 114 to quickly obtain information from one or more entities 116 without previously obtaining contact information for the entity or its agents 108.

The entities can include products, businesses, nonprofit and for profit organizations, government organizations, educational organizations, groups or professional organizations, and members of political organization such as senators and congressmen, and among other entities or groups. The communications to the entities may include a call to action on the part of the entity, such as, issuing a refund or returning an item, purchasing tickets, holding an item, reserving a table, or making an appointment. The communications may also be passive information on a particular topic or regarding a particular item (feedback). The communications can also include background information on the user or the user specific circumstances or past history.

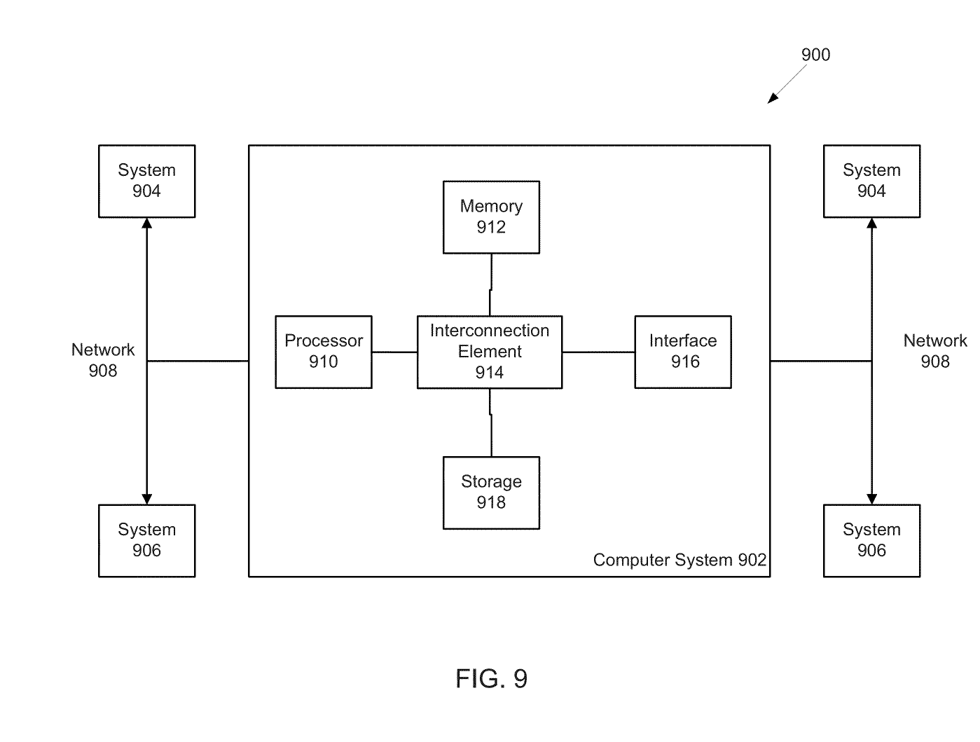

According to various examples, one or more components of the distributed communication system 100 can be implemented using one or more computer systems, such as the distributed computer system 900 discussed below with regard to FIG. 9. Thus, examples of the distributed communication system 100 include a variety of hardware and software components configured to perform the functions described herein and examples are not limited to a particular hardware component, software component or a particular combination thereof. The communication service 102 may be implemented as a cloud-based computing platform, such as the EC2 platform, available from Amazon.com, Seattle, Wash. However, it should be appreciated that other platforms and cloud-based computing services may be used.

For instance, the user may provide one or more inputs to one of the devices 104, such as a cell phone, a feature phone, a smart phone, a PDA, a tablet computer, laptop computer, a desktop computer or other system. According to some examples, feature phones, in contrast with smart phones, are devices that may not provide full features or graphically rich interfaces. As further described below, users of feature phones can use messaging applications provided on their devices to communicate with each other via the communication service 102.

Users 114 may interact with the devices 104 using the personal user interface 110 provided on one of the devices. The personal user interface 110 may allow for inputs using keyword searches, geographical map searches and inputs, location based searching (e.g. within 2 mile radius of the present location), category selections, and other methods of inputting search parameters. The search parameters are transmitted to communication service 102. The communication service 102 can perform a search using those parameters and may send back search results, including results matching one or more entities meeting the search parameters.

In one embodiment, the search results for entities may be ranked according to one or more methods, for example, using the search ranking methods described in U.S. patent application Ser. No. 13/557,912, filed on Jul. 25, 2012, titled, SYSTEMS AND METHODS FOR PROVIDING SEARCH RELEVANCY IN COMMUNICATION INITIATION SEARCHES, which is hereby incorporated herein by reference in its entirety. The ranked searched results can be displayed to the user, via the personal interface 110.

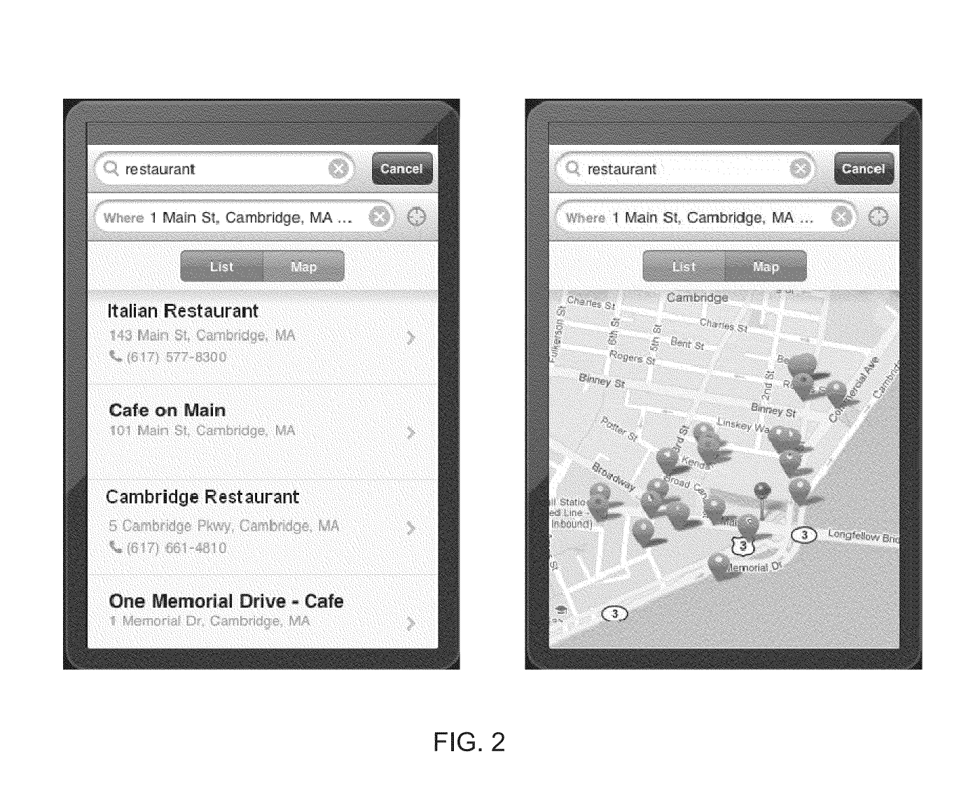

FIG. 2 shows one example of the personal interface 110 with a search performed by a user for a restaurant near the address of the user's current location (e.g. Cambridge, Mass.). The returned results may be displayed to the user as a list of restaurants, with address and contact information. The search results may also be displayed on a map displaying the user's current location and the locations of the search results. In some embodiments, the user may switch between the two display modes.

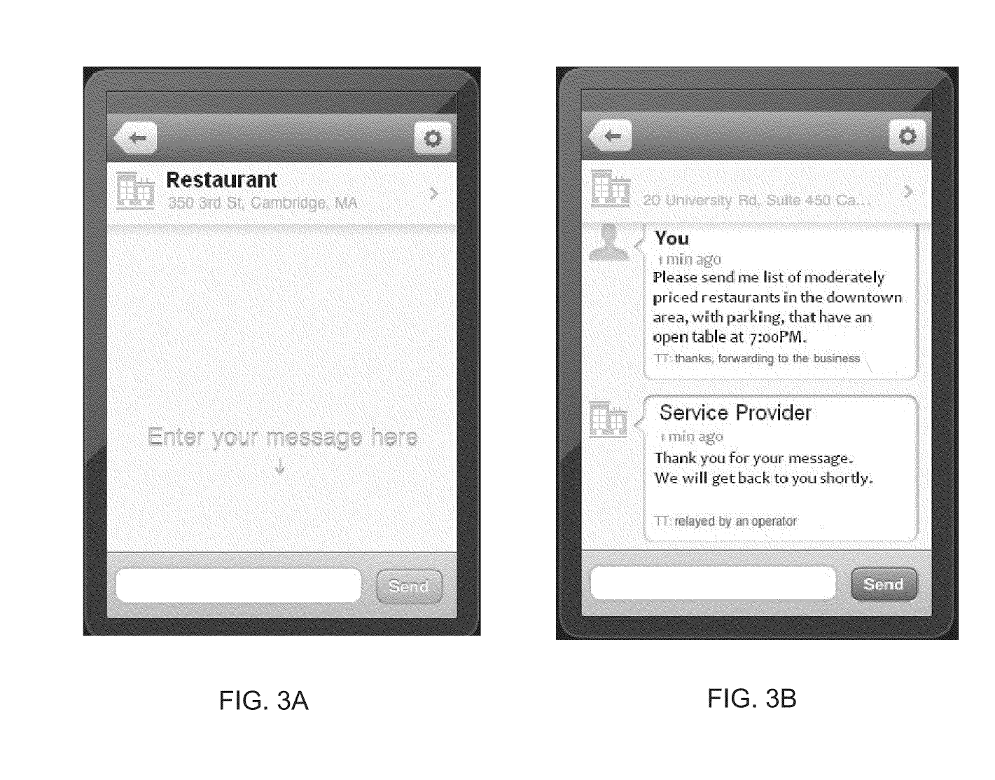

The user 114 may then input a message to one or more of the entities from the returned search list. The message can be one or more words or sentences and may include additional attachments such as documents, emails, messages, images, or videos. Virtually any information can be transmitted as part of the message. The message can be entered into a message field displayed adjacent to the entities on the list. Alternatively, the individual user can first enter the message into the message field and then select one or more entities to receive the message. FIG. 3A shows one example of the personal interface 110 with a message field that allows the user to enter a message to “Restaurant” presented as part of the search results.

In another example, the user 114 does not input search parameters but instead inputs a freeform message into a messaging application on the user's device. The message can be directed to the communication service 102. In one example, the communication service 102 may provide a designated communication channel (e.g. email address or a phone number) to which the user, via the device, can direct messages to the communication service. The message may reference particular entities, include a search query, include a query including a category of entities and/or include a general message.

In one example, the user 114 can send a general message or a message directed to a particular category of entities in the context of the message. Instead of selecting a particular entity from the search results, the user can direct this message to the communication service 102 directly through the designated communication channel. For example, as shown in FIG. 3B, the user can input a message to the communication service requesting a list of moderately priced restaurants in the downtown area, with parking, with an open table at 7:00 PM. In another example, the general message can let a city's park department know that a particular tree in the park has termite damage.

In another example, the message may be targeted to particular individual. For instance, the message inquires about a particular state senator's position on a political issue or legislation of concern to the individual user. The message can also inquire or request information about a product without first locating manufacturer information. For instance, the individual user may wish to communicate feedback regarding defective home appliance and may reference a product number in the message.

Referring again to FIG. 1, the messages can then be transmitted to the communication service 102. The communication service 102 can generate a multi-user chat session between the communicating user and the entity. According to some examples, if the entity the user is attempting to contact is not available to respond, the communication service can take one or more steps to obtain a response to the message. Responses can be received from the entities or from the call center and displayed to the user in the chat session via the personal interface.

In one embodiment, the communication service may provide for one or more entities or users to establish presence in the system and also to establish communications in a brokered chat system using for example, the communication service described in U.S. patent application Ser. No. 13/612,090, filed on Sep. 12, 2012, titled SYSTEM AND METHOD FOR ESTABLISHING PRESENCE IN A BROKERED CHAT SYSTEM, which is hereby incorporated herein by reference in its entirety.

According to some examples, the steps include transmitting the message to one or more entities 116 directly via one or more communication channels, transmitting the message to the call center 112, or auto-generating a response to the message by the to communication service 102. In one example, one or more of the steps can be performed simultaneously. In one example, the entities and the call center can send messages back to the user for further clarification, additional details or notifying the user of the status of the response. The communication service can receive responses from the entities, or from the call center 112 and may be displayed to the user in the chat session via the personal interface on the user's device.

The call center 112 can obtain one or more responses to the message from the entities on behalf of the user or search for the information to respond to the user inquiries. According to some examples, the call center may function as a personal assistant and obtain user requested information from one or more entities regardless of the communication channels available to the user and the entity. In the example of FIG. 3B, the user may send a message requesting a list of moderately restaurants in the downtown area, with parking, with an open table at 7:00 PM. The call center 112 can search for restaurants in the downtown area matching the user's description and further contact the restaurants to determine availability. The call center 112 can then send the matching restaurants to the user via the communication service 102. In another example, the call center can communicate with an entity that may not be configured to receive messages directly through the communication service. In this example, the call center 112 can search for any available of contact information for the entity and communicate the entity on behalf of the user to obtain the requested information.

In one example, auto-generated steps can include generating the response by communication service 102 based on information accessible from a database. In some examples, the auto-generated steps can be performed instead of or in addition to the call center steps or the direct communication steps. Such information may be obtained from publically and privately available databases and/or third party services. In one implementation, the communication service can determine whether the response can be automatically generated and processes the message accordingly. For example, the communication service 102 can generate a response from information relating to contact information, directions, hours of operation, directions to particular stores, store locations, as well as any other information available from a database.

In one example, the entity, via the entity interface, may configure token responses designed to respond to frequently requested information. For example, the entity can provide token responses to any requests or inquiries that may not be accessible from a database, such as holiday hours, today's specials, or ongoing sales, website outages, ongoing litigation, pending investigations, future product releases, store openings and other frequently occurring inquiries. The communication service 102 can also communicate with a service or interface provided by the entities or third parties to generate the response. For example, third party services or interfaces can provide information to the communication service 102 on demand or search query from the communication service. For example, the third party and entity services/interfaces can provide menu items, movie times, restaurant reservations, inventory lists and other information or services provided by entities and third parties.

### Input of Structured Data

To provide accurate information to the user, businesses need to receive accurate and complete information from the user. For example, to make a reservation at the request of the user, a restaurant may need various items of information from the user, such as date and time for the reservation, total number in the party, and contact information for the requesting party. If a user provides incomplete information, the restaurant may need to follow up with the user through the communication service 102 and to request for the user to enter the missing information. Therefore, according to various embodiments, the personal interface 110 provides an interface to enter structured information or semi-structured information. The structured information may be tailored to the particular user inquiry and may further ensure that complete information is provided to the business.

It is appreciated that the personal interface 110 may provide for a user to enter the information through an input device such as a keyboard. The keyboard may be a virtual keyboard provided visually on a touch screen of the device 104 or a physical keyboard provided on the device 104. A typical keyboard on a typical device 104, in order to save screen or device space, provides for entry of alphabetic characters as a main method of input and numeric characters and symbols as a secondary method of input. For example, some keyboards include a number/symbol selection option, which when selected by the user, displays a separate window that allows the user to enter numeric characters and symbols. In other devices, the user may select an additional selection option or key to input numbers and symbols. It is appreciated that such keyboards may not provide an easy way to enter text that is formally correct with punctuation or symbols, such as, for example, dates (e.g. “Wed 2/28”) or times (e.g. “11:28 am”) may need a user to go between multiple windows or press a number of additional keys.

According to various embodiments, the personal interface 110 provides for the user to enter formally correct and complete communication information by providing for the user to choose from predefined text strings to input the structured information for the entity inquiry. The personal interface 110 provides for the user to enter and provide structured or semi-structured information using interfaces and modules that may be already familiar to the user.

The structured information may include any information that may be commonly used to communicate with an entity, for example, menu information, take out and delivery information, reservation information, parcel tracking information, appointment information, or car or taxi service reservation or dispatch information, as well as any other information that may include a predefined set of information requested by a business in a transaction. For example, if the user is interested in requesting a taxi, the structured information can include, date, time, starting location, destination location, contact name and number for the person, type of taxi, and the number of passengers.

The structured information received from the user by the communication service 102 can be provided to the entity using any of the entity's communication channels described above (e.g. email, phone, or text messaging). In one example, the structured information can be provided to a third party service, such as a restaurant reservation service or interface, which can communicate to the user on behalf of the entity.

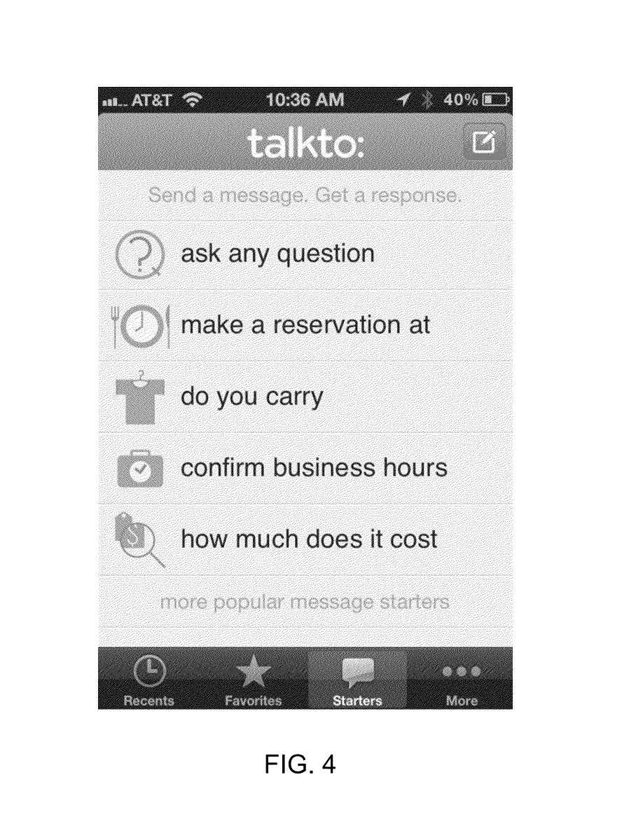

One embodiment of a personal interface 110, which provides a method of inputting structured information, is described with reference to FIGS. 4-8B. FIG. 4A shows one example of the personal interface 110 that provides for the user to input structured information. In one example, the interface displays a list of “starters” or common inquires that can be input and edited by the user and subsequently provided to one or more entities. The list of common inquires can include free form inquiries (e.g. “ask any question” option), or structured form inquires for making reservations, inventory checks, logistics and dispatch information, business hours inquires and price checks (e.g. “make a reservation at,” “do you carry,” “confirm business hours,” or “how much does it cost”). In other embodiments, the personal interface 110 may display to the user common message inquires (e.g. starters) previously received by the communication service 102 from other users of the communication service 102.

In one example, the common inquires, displayed via the personal interface 110, can be organized into categories, for example, by entity category such as dining, hospitality, entertainment, retail, as well as other categories. Within each category, a number of common inquires can be included. For example, for a restaurant, a reservation inquiry, hours of operation inquires, inquires about specials, or menu related inquires can be included.

In at least one embodiment, the user may also be able to create custom structured form inquires for that particular user's common inquires in the personal interface 110. For example, a user looking for work may create a custom inquiry asking if a business is accepting applications for employment. In another embodiment, entities may create common inquires which may be visible and accessible for the user in the personal interface 110 when the user searches for and selects an entity from the search results as shown in FIGS. 3A and 3B. For example, a college or university may provide for students to enter common inquires to registration, housing, student account offices, financial aid or other offices on campus.

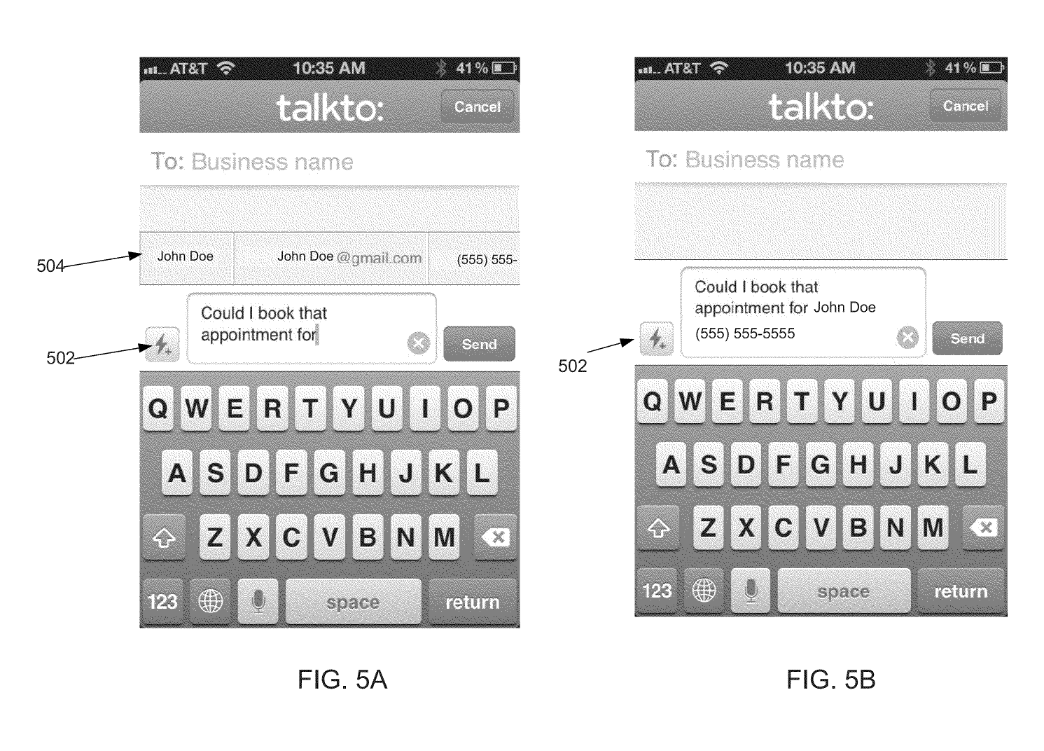

According to one example, the user selects one of the structured form inquires and the inquiry is input into a text messaging or communication field. FIGS. 5A and 5B show the structured form text entered into a message field (e.g. “could I book that appointment for”). This message field is similar to the message field shown in FIGS. 3A and 3B. The user can enter entity information to whom the user would like to direct the message (e.g. in the “To:” field), as well as input additional information into the message field using the keyboard, displayed in FIGS. 5A and 5B as a virtual keyboard.

In addition, in proximity of the message field, the personal interface 110 can provide an auto-text button 502, which may provide for the user to enter any number of predetermined text strings. In response to the user selecting the auto-text button 502, in one example, the personal interface 110 displays a scroll bar 504 above the message field, which displays the predetermined text strings. The scroll bar may be a rectangular area that includes buttons each of which may contain text available to be inserted for the particular user. The text strings may be predetermined based on the type of common to inquiry selected in FIG. 4. As shown in the example in FIGS. 5A and 5B, the scroll bar 504 includes predetermined input for the name of the person looking to book an appointment, and the person's contact information. For other common inquiries, such as those displayed in FIG. 4, other text strings may be displayed. For example, for date and time, today's date and time information, for a location, the user's personal home address, or current location coordinates may be displayed as auto-text. In addition, in one example, the auto-text can be ordered or sorted based on one or more predetermined rules. For example, the auto-text can be ordered based on frequency of use, or the most relevant based on inquiry type of the entity type.

The user can scroll and then select appropriate text strings within the scroll bar by tapping on one of the text strings. As the result of the user taping on one of the text strings in the scroll bar 504, in one example, the selected text string may be inserted at the right point of the previously entered text in the message field. According to some embodiments, the auto-text button 502 may be provided in any messaging window or interface provided to the user, such as the message window shown in FIGS. 3A and 3B.

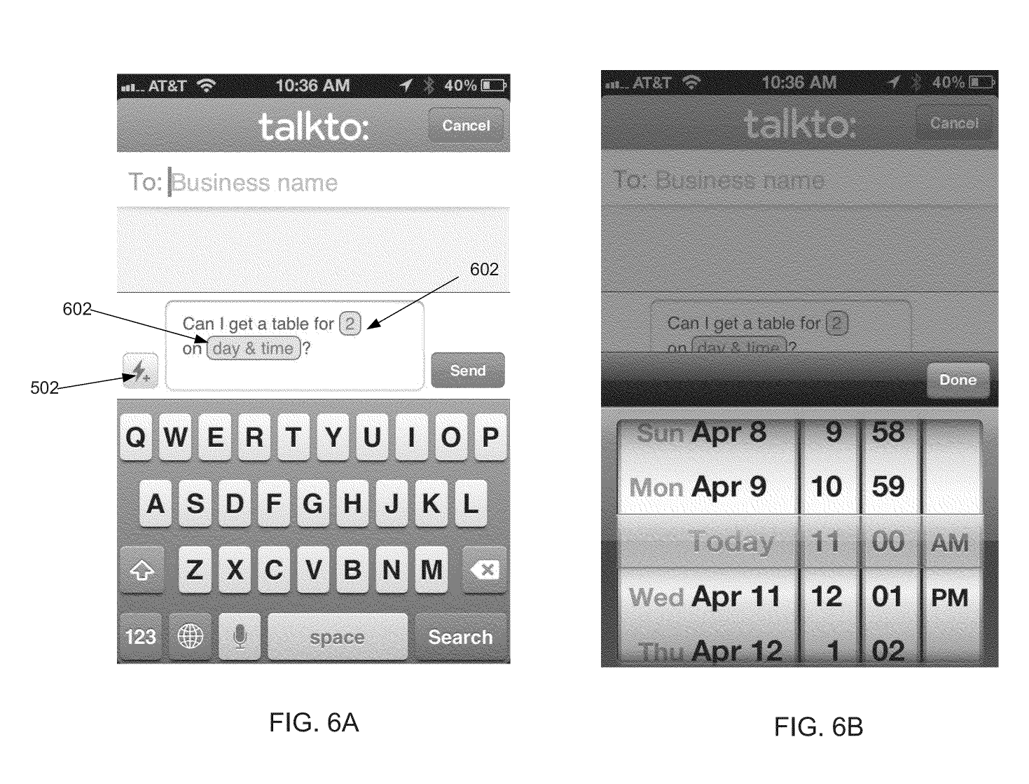

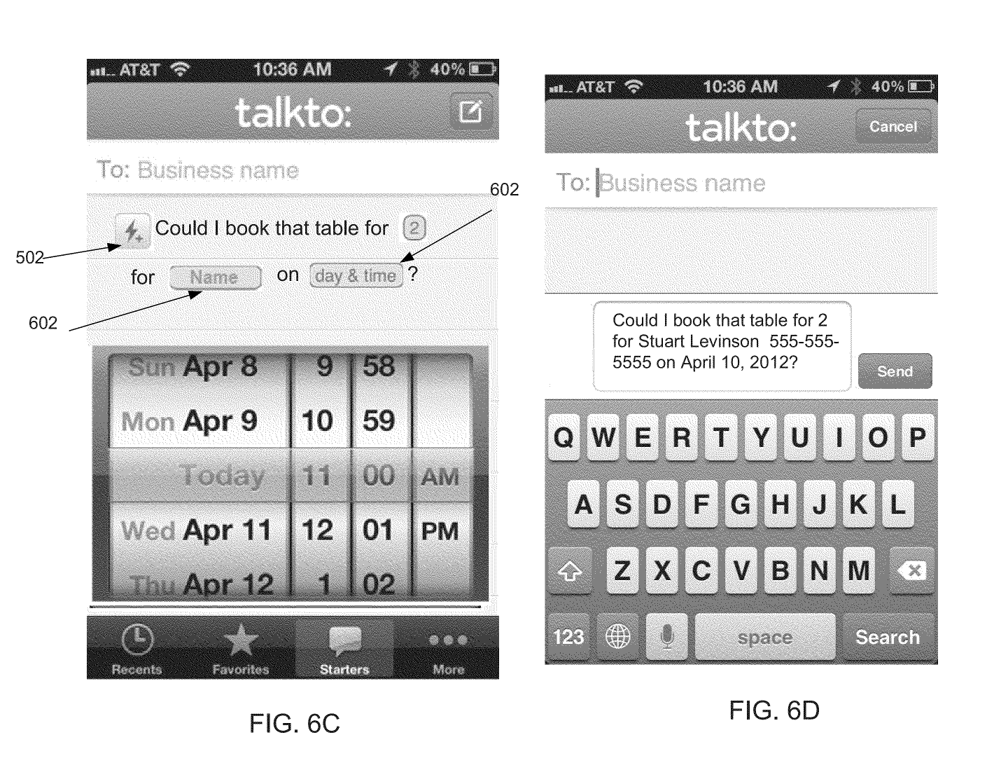

FIGS. 6A and 6B show structured data input for another common inquiry according to another example. In this example, the user selected a common inquiry for making a reservation, and the common inquiry text for that common inquiry is input into a text messaging or communication field (e.g. “Could I get a table . . . ”). In addition to the auto-text button 502, the common inquiry text may include one or more prompt-buttons 602 embedded within the text input in the message field. The prompt-buttons 602 may be displayed in a way that is distinguishable from the remaining inquiry text (e.g. displayed as differently colored rectangles), so that a user may recognize that additional input is needed.

As the result of selecting one of the prompt-buttons 602, the personal interface 110 may display a module within the personal interface 110, which allows for quick user input of formally structured data. In the example shown in FIG. 6A, the prompt-buttons 602 include a module for entering the number of people (e.g. 2) and another module for entering the date and time of the reservation (e.g. date & time). FIG. 6B shows one example of a module for entering the date and time of the reservation, which is displayed in place of the virtual keyboard and allows selections to replace the prompt-button text. In this example, the module includes a device-specific date and time module comprising a selection scroll wheel. Using the module, the user can scroll through the available date and time selections and select the appropriate date and time. As the result of user selection, the date and time information can replace the prompt-button text 602 within the message field.

In at least one embodiment, the personal interface 110 can provide for the user to enter the information into the structured inquiry, provided by the personal interface 110 apart from the message field. The personal interface 110 can receive the information entered into the structured inquiry form by the user and input the information in the message field of the personal interface 110. In one example, as shown in FIGS. 6C and 6D, the user selected a common inquiry for making a reservation, and the common inquiry text for that common inquiry is displayed for the user on the personal interface 110. As shown in FIG. 6C, the common inquiry test can be displayed for the user apart from the text messaging field. Similarly to FIGS. 6A and 6B, the personal interface 110 may provide the auto-text button 502. In addition to the auto-text button 502, the common inquiry text may include one or more prompt-buttons 602 embedded within the text input in the message field. The prompt-buttons 602 may be displayed in a way that is distinguishable from the remaining inquiry text (e.g. displayed as differently colored rectangles), so that a user may recognize that additional input is needed. The user enters the information using the prompt buttons and the system enters the common inquiry text along with the entered prompt-button text into the text messaging or communication field in the form of a text, as shown in FIG. 6D.

The module display as the result of the user selecting the prompt-button may be predetermined based on the type of common inquiry selected by the user. For example, the common inquiry “how much does it cost” may include prompt-buttons for entering price information by displaying a module including a scroll wheel comprising a list of prices. Common inquiry “confirm business hours” may include a prompt-button for entering dates or categories of days by displaying a module comprising a scroll wheel further comprising different categories, such as “weekdays,” “weekends” or “holidays.”

Various prompt-buttons may provide access to other device-specific or third party modules. For example, the modules may provide access to camera applications, bar-code scanners, shopping applications, or other applications installed on the device. The modules may also provide access to third party services such as movie times, car reservations, menus or other modules or services. The modules may be accessed through prompt-buttons displayed within the common inquiry text in the message field as described above. In at least one example, the modules may be accessed through prompt-buttons displayed embedded in the result of searches for entities as shown in the example of FIG. 2. In another example, the modules may be accessed through prompt-buttons displayed in the entity information window, for example, the information windows shown in FIG. 3A.

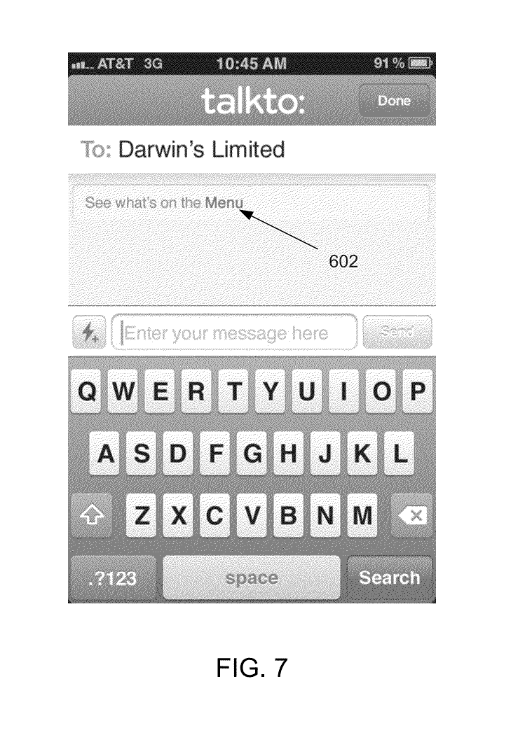

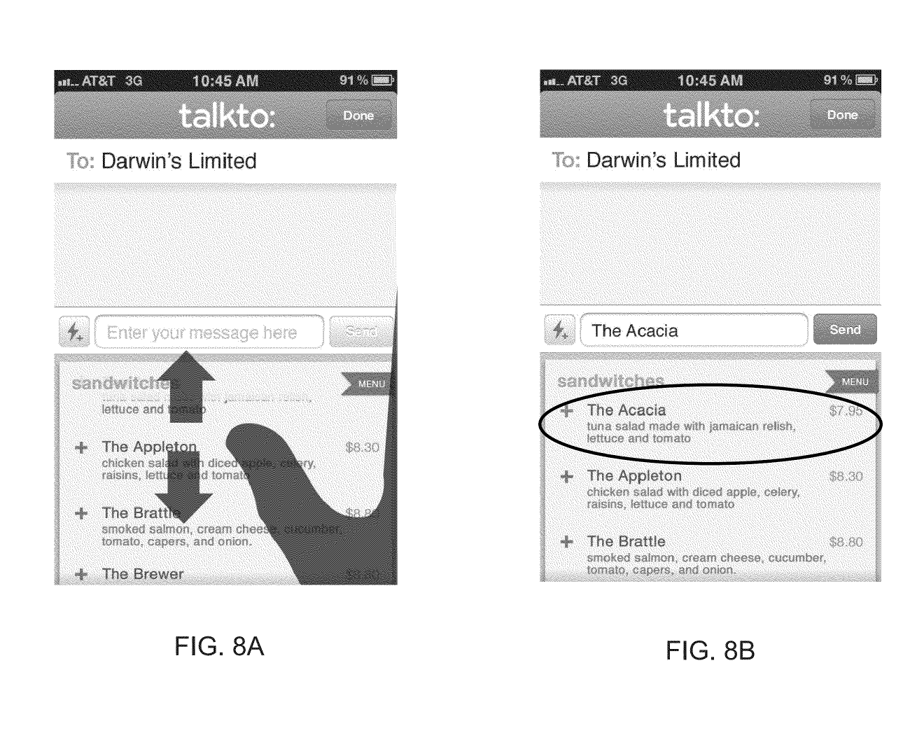

Different prompt-buttons to access different modules may be available for different entities located using the search features. One example of a menu selection module is shown in FIGS. 7, 8A and 8B. In this example, the user inputs a restaurant name into the entity input field (e.g. “Darwin's Limited” entered in the “To:” field). In this example, if the menu module is available for that particular entity, the prompt-button 602 is displayed in the entity information window shown in FIG. 7.

By selecting the prompt-button 602, the personal interface shows a menu module comprising menu items for the selected business. The user can select one of the items on the menu by tapping the item in the module, which can then be input into the message field. As shown in the example of FIGS. 8A and 8B, the menu module is displayed in place of the virtual keyboard in the personal interface 110. In this example, the message field is displayed above the menu module. The user can review the various menu items by scrolling up and down in the menu module (shown in FIG. 8A) and select the menu items the user would like to order, for example “the Acacia sandwich,” which in this example, is entered as text into the message field (shown in FIG. 8B).

According to at least one example, the personal interface 110 on the device 104 may request and receive the information to be displayed in the modules from the communication service 102. Alternatively, the information may be stored locally on the device 104. In one example, the personal interface 110 via the device 104 may request and receive the information from a third-party service or interface. According to another example, the module may be a third-party module, which may be embedded into the personal interface 110.

In other embodiments, a list of common entity responses may be displayed to the entity or agent communicating on behalf of the entity via the entity interface described above. Similarly, the entity or agent within the entity interface may be provided with an auto-text button and a prompt-button which may allow the entity or agent to tailor a response to an inquiry based on common inquiries. The entity may similarly enter these responses using modules provided within the entity interface.

### Example Implementation

Various aspects and functions of the interfaces and services for inputting structured form data described above may be implemented using an iOS mobile platform and Software Development Kit (SDK) which is described below. However, it should be appreciated that the following description is for example purposes and other mobile platforms along with other SDKs may be used to implement the interfaces and services described.

In the examples described above, in order to provide the prompt-buttons mixed with standard text in the message field, rich-text formatting (e.g. formatting similar to the HTML language formatting) may be needed to display a part of text (prompt-button) in a way that differentiates the prompt-button from standard editing text. In addition to rich-text formatting, a method of providing for the user to input and edit the prompt-button text and replace it by typing may also be needed.

In one example, the rich-text formatting and the prompt-button input may be implemented using a Software Development Kit (SDK) such as the iOS Software Development Kit, available from Apple, Inc, Cupertino, Calif. In one example, the standard object for iOS to display HTML text (e.g. UIWebView), using a new HTML5 DOM property (e.g. “contentEditable”) may be used.

According to various examples, a UIWebView object is innitiated which may be the same size of desired input box. The input box may be positioned on the screen of the device 104 where a standard input box may be displayed. The interacting with the UIWebView object may be accomplished using iOS methods and Javascript.

According to at least one example, the interaction is a two-way interaction including the application (e.g. personal interface 110) to Javascript and Javascript to application. First, WebView may be able to indicate whether a user taps on a button inside the text within the interface. As the result of the detection, a scroll bar may be displayed with appropriate text buttons, such as the scroll bar 504 of FIG. 5 or the scroll wheel of FIG. 6B. Second, WebView may need to be informed that the button text is to be replaced by user's choice or selection from the scroll bar.

In one example, the first interaction (Javascript to App) is accomplished using standard UIWebView Delegate method (such as UIWebView: shouldStartLoadWithRequest: navigationType:). In one example, as the result of the user touching or selecting the prompt-button (or any other event requested), the UIWebViewDelegate method causes the WebView to change its location URL because user clicked a link. The application (e.g. personal interface 110) may be notified of this request and sent a destination URL crafted by Javascript to carry information. The application may extract information from URL and indicate to the WebView to ignore the location change (e.g. not to follow the URL link). The scroll bar can be displayed in the application, in response to the receipt of the URL information.

In one example, the second interaction (e.g. application to Javascript), is accomplished by using WebView JavaScript engine including addional JavaScript code. In this example, invoking the standard UIWebView method with predefined JavaScipt parameters, causes a call to the Javascipt code, which return a result (e.g. the user selection in the scroll bar). As the result of receiving the return, the WebView text may change to reflect the user selection.

Both interactions may use different parameters to allow several ways of interaction and better integration. For example, using differnt parameters may allow to move focus from iOS input boxes to UIWebView in response to user choice. In one example, it may be desirable to show the WebView input box together with other SDK standard input boxes and provide for the user to switch between boxes as permitted by the mobile operating system. However, when WebView is selected, it may first result in the keyboard hiding (e.g. downward animation). As the internal JavaScript engine is initiated, the keyboard may appear again (e.g. upward animation), for example because the content is an input box.

These two events generate a keyboard animation as if being dismissed (e.g. downward annimation, but this animation may be abruptly stopped and replaced by an opposite movement (e.g. upward annimation). To remove the keyboard animation, the events are intercepted just before keyboard begins upward or downwards animation. In one example, a screenshot of the keyboard on screen is taken and saved as an image. The saved image may be overlayed over the actual keyboard screen part in order to hide the movement. As the event is intersepted before keyboard upward animation, the image of the keyboard is removed. In this example, the interpetion of the events and the overlaying of the image of the keyboard are transparent to the user.

Additional undesired visual attributes may appear as the result of using the UIWebVIew. For example, the two event may generate shaking of WebView content (prompt-button text) following keyboard animation (e.g. first it moves down then up again). Reducing the generated shaking may be accomplished by using a contentOffset property. In one example, the contentOffset position may be compelled to be moved into appropriate position which may prevent the down-up shaking. Another example of an undesired attribute is the grey area (shadow) around the WebView input box text. In one example, the content of the WebView's scrollView instance, which makes up the global grey shadow, is examined and the UIImageView content is removed.

Additionally, in another example, the WebView keyboard may differ from the standard keyboard displayed on the device 104 by featuring an accessory view placed on top with three buttons “Previous,” “Next” and “Done.” This view may extend the keyboard height to use more than half of the screen. In some examples, this view is removed when it appears in order to provide more space to for the layout the scroll bar. It may also be desirable to provide a keyboard visually consistent with other input fields. To accomplish, the application window list is examined to search for a window whose class is not a real UIWindow; which is the keyboard. Further examining the subviews until finding that accessory view, the keyboard is detected and the class name is verified that corresponds to a special well known string.

According to one example, instead of forcing focus in the WebView instance, the focus is input to be in the WebView, and the keyboard is forced to instantiate by underlaying a standard input box, hidden below WebView. As the result, the keyboard is shown, but the typed text may be lost until the user realizes that a selection is needed for the WebView to insert text.

### Computer System

Various aspects and functions of the systems and services describe above with respect to FIGS. 1-8B may be implemented as specialized hardware or software components executing in one or more computer systems. There are many examples of computer systems that are currently in use. These examples include, among others, network appliances, personal computers, workstations, mainframes, networked clients, servers, media servers, application servers, database servers and web servers. Other examples of computer systems may include mobile computing devices, such as cellular phones and personal digital assistants, and network equipment, such as load balancers, routers and switches. Further, aspects may be located on a single computer system or may be distributed among a plurality of computer systems connected to one or more communications networks.

For example, various aspects and functions may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Consequently, examples are not limited to executing on any particular system or group of systems. Further, aspects and functions may be implemented in software, hardware or firmware, or any combination thereof. Thus, aspects and functions may be implemented within methods, acts, systems, system elements and components using a variety of hardware and software configurations, and examples are not limited to any particular distributed architecture, network, or communication protocol.

Referring to FIG. 9, there is illustrated a block diagram of a distributed computer system 900, in which various aspects and functions may be practiced. The distributed computer system 900 may include one more computer systems that exchange (i.e. send or receive) information. For example, as illustrated, the distributed computer system 900 includes computer systems 902, 904 and 906. As shown, the computer systems 902, 904 and 906 are interconnected by, and may exchange data through, a communication network 908. The network 908 may include any communication network through which computer systems may exchange data. To exchange data using the network 508, the computer systems 902, 904 and 906 and the network 908 may use various methods, protocols and standards, including, among others, Fibre Channel, Token Ring, Ethernet, Wireless Ethernet, Bluetooth, IP, IPV6, TCP/IP, UDP, DTN, HTTP, FTP, SNMP, SMS, MMS, SS7, JSON, SOAP, CORBA, REST and Web Services. The computer systems may also communicate through a cellular radio network access such as Global System for Mobil communication (GSM), General Packet Radio Services (GPRS), Enhanced Data GSM Environment (EDGE), Wideband Code Division Multiple Access (WCDMA), among other communication standards. The network may further employ a plurality of cellular access technologies including 2nd (2G), 3rd (3G), 4th (4G or LTE) generation radio access for cellular systems, WLAN, Wireless Router (WR) mesh, and the like. Access technologies such as 2G, 3G, 4G and LTE and future access networks may enable wide area coverage for mobile devices. In essence, network may include any communication mechanism by which information may travel between the devices and another computing device in the network.

To ensure data transfer is secure, the computer systems 902, 904 and 906 may transmit data via the network 908 using a variety of security measures including, for example, TLS, SSL or VPN. While the distributed computer system 900 illustrates three networked computer systems, the distributed computer system 900 is not so limited and may include any number of computer systems and computing devices, networked using any medium and communication protocol.

As illustrated in FIG. 9, the computer system 902 includes a processor 910, a memory 912, an interconnection element 914, an interface 916 and data storage 918. The processor 910 may perform a series of instructions that result in manipulated data. The processor 910 may be a commercially available processor such as an Intel Xeon, Itanium, Core, Celeron, Pentium, AMD Opteron, Sun UltraSPARC, IBM Power5+, or IBM mainframe chip, but may be any type of processor, multiprocessor or controller. The processor 910 is connected to other system components, including one or more memory devices 912, by the interconnection element 914.

The memory 912 may be used for storing programs and data during operation of the computer system 902. Thus, the memory 912 may be a relatively high performance, volatile, random access memory such as a dynamic random access memory (DRAM) or static memory (SRAM). However, the memory 912 may include any device for storing data, such as a disk drive or other non-volatile storage device. Various examples may to organize the memory 912 into particularized and, in some cases, unique structures to perform the functions disclosed herein and these data structures may be tailored to store values for particular types of data.

Components of the computer system 902 may be coupled by an interconnection element such as the interconnection element 914. The interconnection element 914 may include one or more physical busses, for example, busses between components that are integrated within a same machine, but may include any communication coupling between system elements including specialized or standard computing bus technologies such as IDE, SCSI, PCI and InfiniBand. Thus, the interconnection element 914 enables communications, such as data and instructions, to be exchanged between system components of the computer system 902.

The computer system 902 also includes one or more interface devices 916 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch windows, printing devices, display windows, speakers, network interface cards, etc. Interface devices allow the computer system 902 to exchange information and communicate with external organizations, such as users and other systems.

The data storage 918 may include a computer readable and writeable nonvolatile (non-transitory) data storage medium in which instructions are stored that define a program or other object that may be executed by the processor 910. The data storage 918 also may include information that is recorded, on or in, the medium, and this information may be processed by the processor 910 during execution of the program. More specifically, the information may be stored in one or more data structures specifically configured to conserve storage space or increase data exchange performance. The instructions may be persistently stored as encoded signals, and the instructions may cause the processor 910 to perform any of the functions described herein. The medium may, for example, be optical disk, magnetic disk or flash memory, among others. In operation, the processor 910 or some other controller may cause data to be read from the nonvolatile recording medium into another memory, such as the memory 912, that allows for faster access to the information by the processor 910 than does the storage medium included in the data storage 918. The memory may be located in the data storage 918 or in the memory 912, however, the processor 910 may manipulate the data within the memory 912, and then copy the data to the storage medium associated with the data storage 918 after processing is completed. A variety of components may manage data movement between the storage medium and other memory elements and examples are not limited to particular data management components. Further, examples are not limited to a particular memory system or data storage system.

Although the computer system 902 is shown by way of example as one type of computer system upon which various aspects and functions may be practiced, aspects and functions are not limited to being implemented on the computer system 902 as shown in FIG. 9. Various aspects and functions may be practiced on one or more computers having a different architectures or components than that shown in FIG. 9. For instance, the computer system 902 may include specially programmed, special-purpose hardware, such as an application-specific integrated circuit (ASIC) tailored to perform a particular operation disclosed herein. While another example may perform the same function using a grid of several general-purpose computing devices running MAC OS System X with Motorola PowerPC processors and several specialized computing devices running proprietary hardware and operating systems.

The computer system 902 may be a computer system including an operating system that manages at least a portion of the hardware elements included in the computer system 902. In some examples, a processor or controller, such as the processor 910, executes an operating system. Examples of a particular operating system that may be executed include a Windows-based operating system, such as, Windows NT, Windows 2000 (Windows ME), Windows XP, Windows Vista or Windows 7 operating systems, available from the Microsoft Corporation, a MAC OS System X operating system available from Apple Computer, one of many Linux-based operating system distributions, for example, the Enterprise Linux operating system available from Red Hat Inc., a Solaris operating system available from Sun Microsystems, or a UNIX operating systems available from various sources. Many other operating systems may be used, and examples are not limited to any particular operating system.

The processor 910 and operating system together define a computer platform for which application programs in high-level programming languages may be written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, SmallTalk, Java, C++, Ada, or C# (C-Sharp). Other object-oriented programming languages may also be used.

Alternatively, functional, scripting, or logical programming languages may be used. Additionally, various aspects and functions may be implemented in a non-programmed environment, for example, documents created in HTML, XML or other format that, when viewed in a window of a browser program, render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Thus, functional components disclosed herein may include a wide variety of elements, e.g. executable code, data structures or objects, configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user mode application) or in a commonly shared data structure (such as an application registry that is defined by an operating system). In addition, some examples provide for both system and user interfaces that allow external entities to modify the parameters and thereby configure the behavior of the components.

Having thus described several aspects of at least one embodiment, it is to be appreciated various alterations, modifications, and improvements will readily occur to those skilled in the art. Such alterations, modifications, and improvements are intended to be part of this disclosure and are intended to be within the scope of the invention.

What is claimed is:

1. A computer system for providing structured communication for communication between a user and at least one entity, the system comprising:
a memory;
a display;
at least one processor coupled to the memory and the display, the at least one processor configured to:
provide at least one predefined text string for display to the user on a device, the at least one predefined text string comprising an inquiry to the at least one entity;
receive a structured text input associated with the at least one predefined text string; and
transmit a message to another device having the at least one predefined text string and the structured text input to the at least one entity.

2. The system of claim 1, wherein the at least one processor is further configured to provide the at least one predefined text string comprising inquires pertinent to trade of the at least on entity.

3. The system of claim 1, wherein the at least one processor is further configured to provide the at least one predefined text string comprising common inquiry to a business type associated with the at least on entity.

4. The system of claim 1, wherein the at least one processor is further configured to provide for display to the user an auto-text selection.

5. The system of claim 4, wherein the at least one processor is further configured to provide for display at least one auto-text input adjacent to a messaging field in response to receiving an input associated with the auto-text selection.

6. The system of claim 5, wherein the at least one processor is further configured to input into the messaging field the at least one auto-text input in response to receiving an input selection of the at least one auto-text input.

7. The system of claim 1, wherein the at least one processor is further configured to provide for display at least one prompt selection for entering structured text within the at least one predefined text string.

8. The system of claim 7, wherein the at least one prompt selection comprises a scroll bar displaying a selection of the structured text input.

9. The system of claim 1, wherein the at least one processor is further configured to receive a search input from the user for the at least one entity and to provide search results including the at least one entity based on the search input.

10. The system of claim 1, wherein the at least one processor is further configured to provide at least one predefined text string comprising a plurality of predetermined inquires organized into categories.

11. A method for providing structured communication for communication between a user and at least one entity, the method comprising:
providing at least one predefined text string for display to the user on a device, the at least one predefined text string comprising an inquiry to the at least one entity;
receiving a structured text input associated with the at least one predefined text string; and
transmitting a message to another device having the at least one predefined text string and the structured text input to the at least one entity.

12. The method of claim 11, further comprising providing the at least one predefined text string comprising inquires pertinent to trade of the at least on entity.

13. The method of claim 11, further comprising providing the at least one predefined text string comprising common inquiry to a business type associated with the at least on entity.

14. The method of claim 11, further comprising providing for display to the user an auto-text selection.

15. The method of claim 14, further comprising providing for display at least one auto-text input adjacent to a messaging field in response to receiving an input associated with the auto-text selection.

16. The method of claim 15, further comprising providing into the messaging field the at least one auto-text input in response to receiving an input selection of the at least one auto-text input.

17. The method of claim 11, further comprising providing for display at least one prompt selection for entering structured text within the at least one predefined text string.

18. The method of claim 17, further comprising providing for display the at least one prompt selection comprising a scroll bar displaying a selection of the structured text input.

19. The method of claim 11, further comprising receiving a search input from the user for the at least one entity and to provide search results including the at least one entity based on the search input.

20. A non-transitory computer readable medium providing structured communication for communication between a user and at least one entity, having stored thereon sequences of instruction that are capable of causing at least one processor to:
provide at least one predefined text string for display to the user on a device, the at least one predefined text string comprising an inquiry to the at least one entity;
receive a structured text input associated with the at least one predefined text string; and
transmit a message to another device having the at least one predefined text string and the structured text input to the at least one entity.
